(19) United States
(12) Patent Application Publication
(10) Pub. No.: US 2006/0016661 A1
(43) Pub. Date: Jan. 26, 2006

(54) Device for operatively connecting an internal combustion engine to a transmission

(75) Inventors: Philip George, Wooster, OH (US); Gabor Izso, Buhlertal (DE); Jeffrey Hemphill, Copley, OH (US); Patrick Lindemann, Wooster, OH (US); Todd Sturgin, Shreve, OH (US); Scott Schrader, Canton, OH (US); Mark McGrath, Strasburg, OH (US); David Avins, Burbank, OH (US); Steven Olsen, Wooster, OH (US)

Correspondence Address: DAVIDSON, DAVIDSON & KAPPEL, LLC, 485 SEVENTH AVENUE, 14TH FLOOR, NEW YORK, NY, 10018, US

(73) Assignee: LuK Lamellen und Kupplungsbau Beteiligungs KG, Buehl (DE)

(21) Appl. No.: 11/183,388

(22) Filed: Jul. 18, 2005

Related U.S. Application Data
(60) Provisional application No. 60/590,119, filed on Jul. 22, 2004.

(51) Int. Cl. F16D 19/00

(52) U.S. Cl. 192/85 AA; 192/112; 192/212

(57) ABSTRACT

A device for producing an operative connection between an internal combustion engine of a motor vehicle and a downstream transmission is described. The device is a substitute for a torque converter and can be designed as a wet clutch or a torsion damper. The installation space between the internal combustion engine and the transmission does not have to be redesigned. The only requirement for the installation of the device is to replace the transmission/engine control software.

Priority to U.S. Provisional Patent Application Ser. No. 60/590,119, filed Jul. 22, 2004 is claimed, the entire disclosure of which is hereby incorporated by reference herein.

### FIELD OF THE INVENTION

The present invention relates to a device for establishing power flow between an internal combustion engine and a transmission.

### BACKGROUND

It is known from the related art that a torque converter is located between an internal combustion engine and a downstream transmission—preferably an automatic transmission. This torque converter is composed of an outer housing which is composed of two housing shells. One housing shell is connected indirectly to the drive shaft/crankshaft of the internal combustion engine in a non-rotatable manner. The second housing shell faces the downstream transmission. The two shells are interconnected at their point of contact in an oil-tight manner, preferably by means of welding. Pump vanes are located in the shell on the transmission side. Due to the rotary motion of the torque converter, and because the interior of the housing is filled with oil, a toroidal flow results. This flow acts on a turbine, which is also provided with corresponding vanes. The result is rotary motion of the turbine. A stator which returns the oil. flow to the pump in a suitable manner is located in the radially interior region between the turbine and the pump.

Since slippage always exists between the pump and the turbine, and this slippage results in a considerable loss of efficiency, torque converters have been equipped for decades with a converter lock-up clutch. In the closed state, this converter lock-up clutch is a non-rotatable connection between the housing and the transmission input shaft. A damper is often also located in the power flow from the internal combustion engine via the torque converter to the transmission input shaft to minimize rotational non-uniformities. This damper can be designed as a turbine damper or a pure torsion damper.

A torque converter is therefore a very complex component, which also makes it expensive.

### SUMMARY OF THE INVENTION

The object of the present invention, therefore, is to provide a device for operatively connecting an internal combustion engine to a downstream transmission which is a more cost-effective means of achieving the object.

In accordance with certain embodiments of the present invention, the installation space between the internal combustion engine and the transmission remain unchanged, i.e., an existing design implemented using a torque converter can be retained, the only difference being that the device according to the present invention is used instead of the torque converter.

In accordance with an embodiment of the present invention, a device for operatively connecting an internal combustion engine in motor vehicles to a downstream transmission is provided. The device includes an enclosed housing having an axis of rotation. The enclosed housing is at least partially filled with oil, and is hydraulically connectable to an oil pump located outside the enclosed housing. The enclosed housing includes a first housing shell on an engine side of the device and a second housing shell on a transmission side of the device. The first and second housing shells are interconnected in an oil-tight manner. The first housing shell is non-rotatably connected to a driveshaft/crankshaft of the internal combustion engine via a driving disk. A concentric opening is provided on the transmission side of the second housing shell for receiving in a transmission input shaft of the downstream transmission. A hub is located in the interior of the enclosed housing, and the transmission input shaft is non-rotatably connectable to the hub. A piston located in the interior of the enclosed housing. The piston is located concentrically to the axis of rotation of the enclosed housing and is axially displaceable along said axis. A plurality of friction disks are located in a power flow between the housing and the hub, wherein the friction disks can be pressed against each other, directly or indirectly, by the piston, by way of which pressing the power flow between the enclosed housing and the transmission input shaft is controlled.

According to the present invention, to adapt the engine speeds to the rotational speeds of the transmission input shaft, slippage is allowed to occur briefly between the disks of the disk assembly during rotation. The heat which develops as a result is dissipated via an oil cooling system. In this case, it is advantageous when the device according to the present invention is used as a substitute for a torque converter, since a considerable amount of heat is also produced with a torque converter and an external oil pump is therefore also provided for it, the oil pump ensuring continuous oil exchange in the converter. The heated oil is directed to an oil cooling system and at least a portion of it is pumped back to the converter. For this reason, the device according to the present invention—as is the case with a torque converter—may be provided with a pump neck which engages in an oil pump on the transmission side. In a further embodiment of the present invention, a pump neck is not required, however, since, in this case, the oil pump is operated independently of the engine speed, e.g., using an oil pump driven by an electric motor. In a special case of the means of achieving this object, the amount of oil pumped by the oil pump—which is independent of engine speed—can be changed as a function of the temperature which the oil has when it exits the device according to the present invention.

The non-rotatable coupling of the device according to the present invention with the internal combustion engine can take place using a flywheel, whereby the flywheel is mounted non-rotatably on the drive shaft/crankshaft of the internal combustion engine, and the device is also fixed in position, non-rotatably, on this flywheel. The coupling may also be implemented using a flexible disk (i.e., a disk with a low intrinsic mass). A flexible disk of this type is often referred to in the industry as a “flexplate.”

The devices according to the present invention include two preferred embodiments. In a first embodiment, the device is implemented as a wet clutch. In a second embodiment, it is implemented as a torsion damper. These differences will be explained in greater detail in conjunction with the description of the figures.

### BRIEF DESCRIPTION OF THE DRAWINGS

The invention will be explained in greater detail below with reference to the figure description.

FIG. 1 shows a cross section through a wet clutch according to the present invention having a radially outwardly located damper and two discharge devices;

FIG. 2 shows two oil circuits based on FIG. 1;

FIG. 3 shows an oil ring based on FIGS. 1 and 2;

FIG. 4 shows a further embodiment of FIGS. 1 through 3 having a pair of disks as the oil return device;

FIG. 5 shows a further wet clutch according to the present invention with a damper in the center region of the diameter;

FIG. 6 shows a perspective sectional illustration based on FIG. 5;

FIG. 7 shows a torsion damper according to the present invention;

FIG. 8 shows a front view of a friction disk;

FIG. 9 shows a partial view Z from FIG. 8.

### DETAILED DESCRIPTION

First, it should be noted that because the components shown in the figures are largely rotationally symmetrical, circular edges result. Since these edges would greatly impair the clarity of the drawing, they have been largely omitted from the figures.

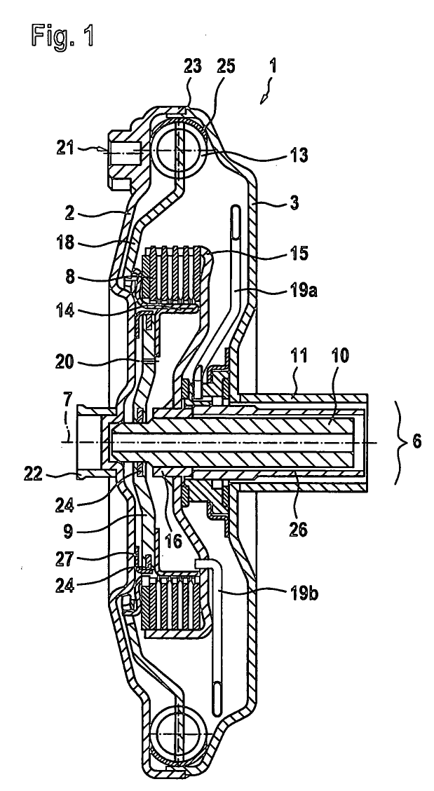

A device according to the present invention is shown in FIG. 1, the device being designed as a wet clutch. This wet clutch is enclosed in a housing 1. Housing 1 is composed essentially of a housing shell 2 on the engine side and a housing shell 3 on the transmission side. Shells 2 and 3 are connected to a weld 23. Housing 1 having a driving disk 4 (flywheel, flexplate, dual-mass flywheel), which is not shown in FIG. 1, is connected in a non-rotatable manner by a plurality of fastening lugs 21 (only one of which is shown in FIG. 1) to a drive shaft/crankshaft 5, which is also not shown in FIG. 1. Housing 1 is guided in a concentric recess of drive shaft/crankshaft 5 using a guide device 22. Housing shell 3 on the transmission side is non-rotatably connected to a pump neck 11 in the region of a concentric opening 6. Pump neck 11 engages in an oil pump 12, which is not shown in FIG. 1. Oil pump 12 is driven by the rotary movement of housing 1 around an axis of rotation 7.

The illustrated wet clutch is provided with a damper. The damper shown here is located in the radially outward region of the wet clutch. Drivers (e.g., cams stamped in housing 1), which are not shown in FIG. 1, rest against one end of damping spring 13. Damping springs 13 are designed in this case as curved spiral coiled springs which rest in a slide channel 25. The other ends of springs 13 act on an outlet part 18 which is in turn interlocked with a first disk carrier 14. Disks (friction disks) 8 are located between this first disk carrier 14 and a second disk carrier 15. Disks 8 are interlocked, in an alternating manner, with either disk carrier 14 or disk carrier 15 and are axially displaceable. Disk carrier 15 is non-rotatably connected to a hub 16. Hub 16 has a multi-toothed profile (not shown) which is complementary with the multi-toothed profile of transmission input shaft 10.

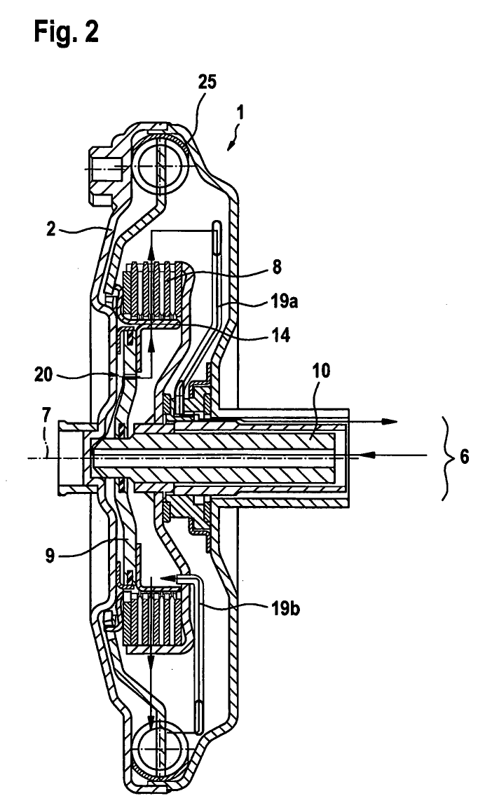

As shown in FIG. 1, transmission input shaft 10 has a bore extending through it. Via this bore, a pumped flow of oil (further details are provided in FIG. 2) travels between housing shell 2 on the engine side and a piston 9. Piston 9 is sealed off from input shaft 10 via an inner gasket 24 and is sealed off from an annular shell 27 via an outer gasket 24. Annular shell 27 is connected to housing shell 2 on the engine side, e.g., via laser welding. If oil pressure now increases between housing shell 2 on the engine side and piston 9, piston 9 presses indirectly against disks 8, since the piston acts on a right-angle bend of disk carrier 14. As the pressure of piston 9 increases, the friction torque in the clutches ultimately increases in such a way that full engine torque and engine speed are transferred to transmission input shaft 10.

To ensure that oil can also be directed over disks 8 without using a further oil passage, piston 9 has a point of restriction 20 which may be designed, e.g., as a stamped-out area. As a result of point of restriction 20, the oil pressure to the left of piston 9 is substantially maintained, while still allowing oil cooling for disks 8 to be implemented.

To make it possible for the oil supplied to the wet clutch to be returned to pump 12 before it overheats, two return devices 19a, 19b retained by a support sleeve 26 are provided in this exemplary embodiment. Support sleeve 26 can be mounted on the wall of a transmission, for example, similar to the support tube for the stator in the case of torque converters.

As mentioned above, the oil circuits in the wet clutch are explained with reference to FIG. 2. An oil flow coming from oil pump 12 is pumped via hollow transmission input shaft 10 in the region between housing shell 2 on the transmission side and piston 9. The piston force increases as a result, and oil flow for disks 8 is implemented via point of restriction 20. To ensure that a good oil supply is possible over preferably all friction surfaces of disks 8, disk carriers 14 and 15 have a plurality of radial passages. FIG. 2 should therefore not be misunderstood to mean that the flow of oil is directed only over the friction surfaces in the center of the disk assembly, as indicated by the arrow. After the oil flows out of the disk assembly, it enters the radially outward region of housing 1—due to the centrifugal force produced by the rotary motion of the wet clutch—where it lubricates the relative motions of damping spring 13 and slide channel 25.

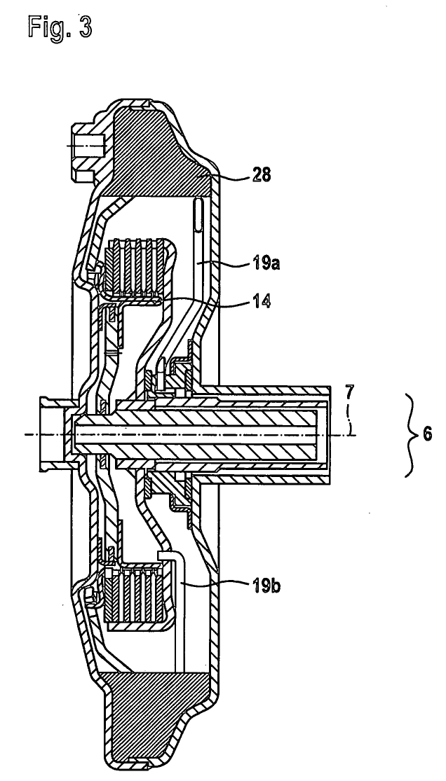

As a result of the centrifugal force, an oil ring 28 forms in the radially outward region of the wet clutch, as shown in FIG. 3. Due to return devices 19a, 19b, which are designed as discharge tubes and are arranged in the shape of a spiral relative to axis of rotation 7, the oil is pumped either into the region of concentric opening 6 or essentially to the inner diameter of disk carrier 14. Return devices 19a, 19b shown here are configured in the shape of a spiral because rotating oil ring 28, due to its kinetic energy, impacts the inlet openings which are located radially outwardly and are not rotating. As a result, the oil is then “screwed” radially back into the interior.

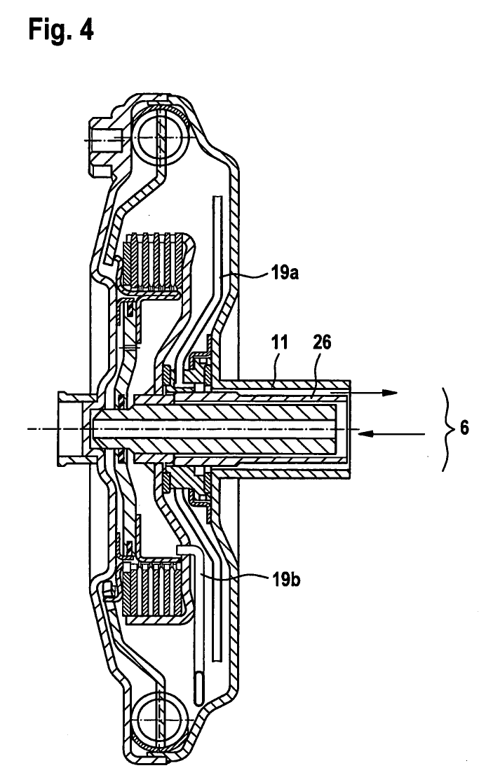

A further embodiment of return device 19a, 19b is disclosed with FIG. 4. Return device 19a, 19b is composed of two parallel disks having an annular passage between them. At their outer diameters, these disks form an inlet opening for the oil to be pumped between pump neck 11 and back to support sleeve 26. This functions in this manner because air is also enclosed in the wet clutch and, therefore, when new oil flows in, the excess oil between the disks of return device 19a is pressed out.

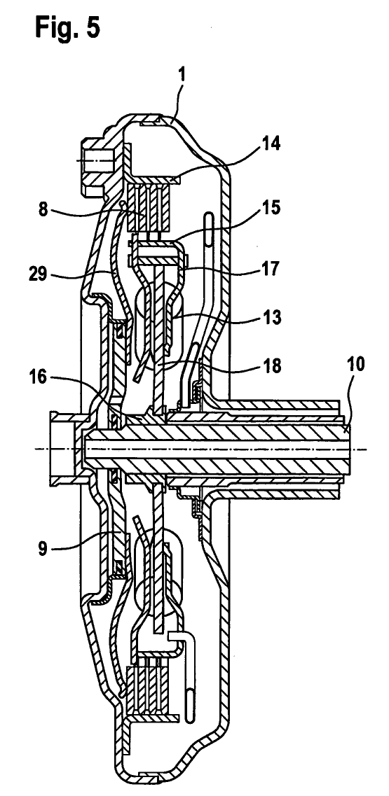

The damper shown in FIG. 5 has a different design from the damper shown in FIGS. 1 through 4. In FIG. 5, springs 13 are located downstream from disks 8 in the power flow from housing 1 to hub 16. This means that the inner disk carrier 15 acts on an inlet part 17. Inlet part 17, in turn, acts on one end of the springs, while the other end of the springs bears against outlet part 18. Since springs 13 in this illustration are not located directly in the section plane, but rather behind the section plane, they look like diagonally positioned cylinders. This cylindrical appearance is also due to the fact that springs 13 do not have a curved design in this case, as in FIGS. 1 through 4, but rather have a substantially cylindrical shape. The purpose of FIG. 5 is to show that the device according to the present invention may also be equipped with this type of damper.

With regard to the exemplary embodiment in FIG. 5, it should be emphasized that piston 9 does not press disks 8 directly, nor does it act directly on disks 8 via a disk carrier 14, 15. Instead, an additional component 29, e.g., designed as a pressure plate or disk spring, exerts the compression force of piston 9 on disks 8.

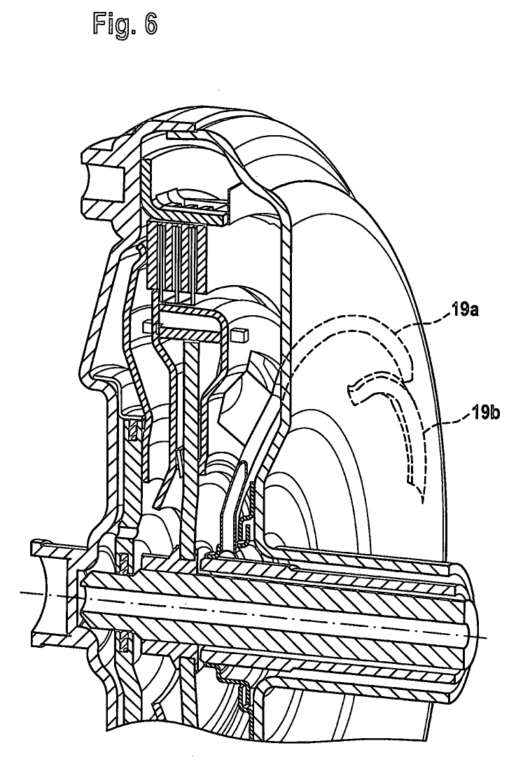

FIG. 6 is provided as a supplement to FIG. 5, with the aim of better illustrating the spiral-shaped character of return devices 19a and 19b.

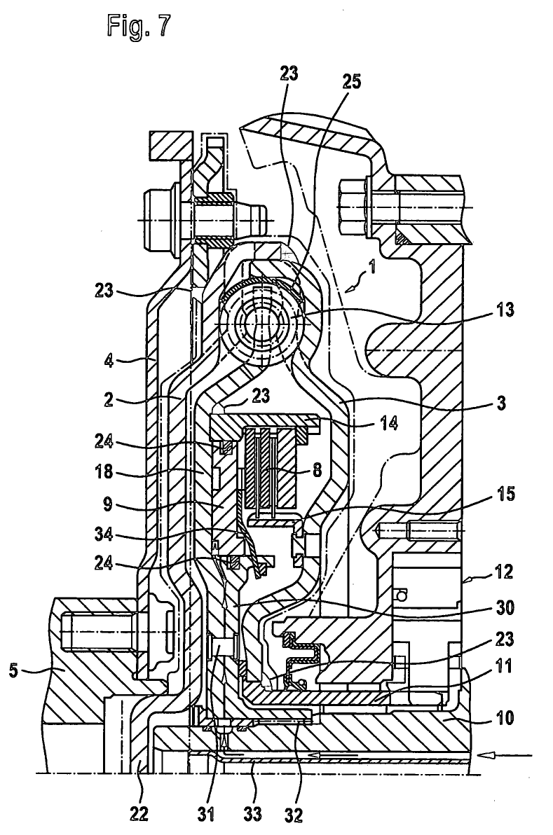

The embodiment of the device according to the present invention shown in FIG. 7 is an adjustable torsion damper. It is clear in this case as well that this damper may be considered to be a substitute for a torque converter, since it is fixed in position to drive shaft/crankshaft 5 with the aid of a driving disk 4 (shown as a flexplate here), as is the case with a torque converter, and power is output via multi-toothed profile 32 into transmission input shaft 10. As is the case with the torque converter, pump neck 11 is also provided here, and it also engages in an oil pump 12. The outlines on the right side of the figure, which are not described in greater detail, represent the outer wall of a transmission on the engine side. This adjustable torsion damper is therefore also located in the power flow between the internal combustion engine and a transmission—preferably an automatic transmission.

As indicated in the drawing, the power flow in this case travels via housing 1 and the indicated drivers (dashed lines) to the one end of springs 13. Springs 13 are arranged in two layers in this case. This means that an inner spring 13 is additionally located in an outer spring 13. In this case as well, springs 13 are located in the radially outward region of the torsion damper and slide on a slide channel 25. Outlet part 18 acts on the other end of the springs. The arrangement of disk carriers 14, 15 and, therefore, disks 8, is an unusual feature in this design, because outer disk carrier 14 is connected to outlet part 18 via a weld 23. Since inner disk carrier 15 is connected to housing shell 3 on the transmission side using a joint composed of rivet buttons, when disks 8 are pressed together (when piston 9 acts on them), it is no longer possible for relative rotary motion to take place between outlet part 18 and the housing. In other words: The power flow would then be through housing 1, disk carriers 14, 15 and disks 8 to outlet part 18. If piston 9 is pressed weakly against disks 8, only a portion of the rotary motion of outlet part 18 relative to housing 1 is captured and converted to thermal energy.

If one considers the further flow of power in this torsion damper, one recognizes that a central component—a piston centering device 30—is non-rotatably connected to outlet part 18. Since a multi-toothed profile 32 is also provided on the central component, which serves simultaneously as a piston centering device 30 in this case, this establishes a non-rotatable connection with transmission input shaft 10.

From the perspective of damping and, therefore, the conversion of rotational vibration energy into thermal energy, it follows that, if disks 8 are not pressed together and if disks 8 are pressed tightly together (no relative motion between disks 8), damping cannot occur.

Since transmission input shaft 10 is hollow in design, oil can be pumped via a radial bore between outlet part 18 and piston centering device 30 using an insert 33. To enable oil to flow here—since outlet part 18 and piston centering device 30 are interconnected via a riveted joint 31—oil guide grooves are provided in at least one of these parts (created via stamping, for example). In this manner, oil may be pumped into the chamber between outlet part 18 and piston 9. If the oil pressure subsides, a return spring 34 ensures that the piston lifts away from disks 8. (Reference numerals in FIG. 7 which are not discussed have the same significance as in the other figures.)

It is apparent from FIG. 7 that insert 33 does not completely fill the interior of transmission input shaft 10. A second oil flow is therefore feasible, which exits at the left end of transmission input shaft 10 in this case and then flows along between housing shell 2 on the engine side and outlet part 18, and is subsequently redirected in the region of springs 13. Using appropriate return devices 19a, 19b (as described initially), the oil may also be pumped over disks 8. This oil, which is used as coolant, could subsequently flow in the gap between pump neck 11 and transmission input shaft 10. A reverse flow of pumped cooling oil would also be feasible within the framework of the present invention.

Finally, it should be stated that a dual-channel oil pumping system is tacitly assumed in the exemplary embodiments shown in FIGS. 1 through 7. Since the described wet clutches and torsion damper are intended to substitute for torque converters, but there are also torque converters which have not only two passages for their oil circulation, but also a third passage for actuating the converter lock-up clutch, it is also feasible within the framework of the present. invention to use a three-passage system of this type in this application. The exemplary embodiments in FIGS. 1 through 7 would then need to be adapted accordingly to this application.

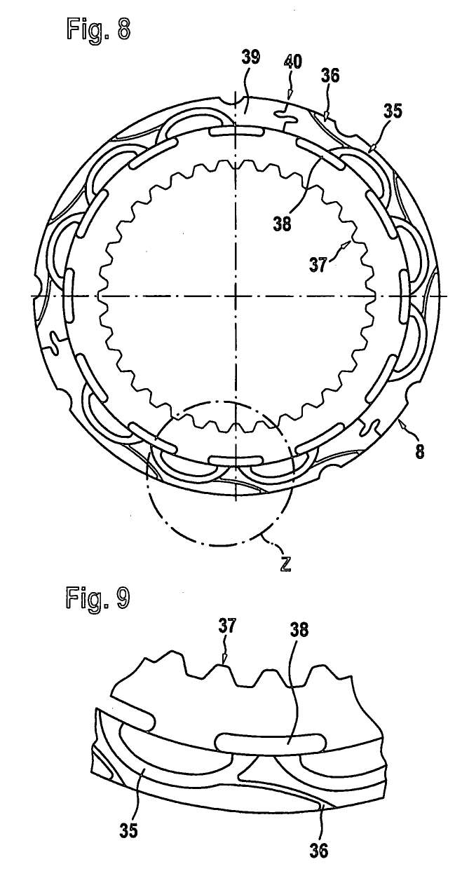

Shown in FIGS. 8 and 9 (which is detail Z from FIG. 8) is a friction disk 8 which is positioned on an inner disk carrier 14, 15 in a torsion-proof but axially displaceable manner via its internal toothing 37. A friction lining 39 is located in an annular shape on the carrier material of disk 8. Friction lining 39 is composed of individual segments which are joined at an S-shaped contact line 40. The carrier material of disks 8 has longitudinal slots 38 outside of the region of the friction lining, which allow oil to flow in an axial direction. Oil grooves 35, 36 are provided in friction lining 39. Oil grooves 35, 36 may be impressed in friction lining 39, for example. The special arrangement and shape of oil grooves 35, 36 are advantageous, however. Oil grooves 35 form a curve which starts at the inner diameter of friction lining 39 and also ends here. Oil grooves 35 have a larger cross-sectional area than oil grooves 36, which essentially contact the curve of oil grooves 35 at an acute angle. Oil grooves 36 also create a flow connection to the outer diameter of friction lining 39. Their orientation relative to large oil groove 35 may also point in the other direction (i.e., other than the direction shown), depending on the direction of rotation of this friction lining relative to the adjacent friction lining and on how the oil is to be pumped via the entrainment effect from the outside to the inside or from the inside to the outside.

### LIST OF REFERENCE NUMERALS

1 Housing
2 Housing shell on engine side
3 Housing shell on transmission side
4 Driving disk
5 Drive shaft/crankshaft
6 Concentric opening
7 Axis of rotation of the housing
8 Disks/friction disks
9 Piston
10 Transmission input shaft
11 Pump neck
12 Oil pump
13 Damper spring (spiral coiled spring)
14 Disk carrier
15 Disk carrier
16 Hub
17 Inlet part
18 Outlet part
19 Return device
20 Point of restriction in the piston
21 Fastening lug
22 Guide device (tab or sleeve)
23 Weld
24 Gasket
25 Slide channel
26 Support sleeve
27 Annular shell
28 Oil ring
29 Pressure plate/disk spring
30 Piston centering device
31 Riveted joint
32 Multi-toothed profile
33 Insert
34 Return spring
35 Oil groove
36 Oil groove
37 Internal teeth of disks
38 Slot
39 Friction lining
40 Contact line

What is claimed is:

1. A device for operatively connecting an internal combustion engine in motor vehicles to a downstream transmission comprising:
an enclosed housing having an axis of rotation, the enclosed housing being at least partially filled with oil, and being hydraulically connectable to an oil pump located outside the enclosed housing, the enclosed housing including
a first housing shell on an engine side of the device, and
a second housing shell on a transmission side of the device, the first and second housing shells being interconnected in an oil-tight manner, the first housing shell being non-rotatably connectable to a driveshaft/crankshaft of the internal combustion engine via a driving disk;
a concentric opening on the transmission side of the second housing shell for receiving a transmission input shaft of the downstream transmission,
a hub located in the interior of the enclosed housing, the transmission input shaft being non-rotatably connectable to the hub;
a piston located in the interior of the enclosed housing, the piston being located concentrically to the axis of rotation of the enclosed housing and being axially displaceable along said axis;
a plurality of friction disks located in a power flow between the housing and the hub, wherein the friction disks can be pressed against each other, directly or indirectly, by the piston, by way of which pressing the power flow between the enclosed housing and the transmission input shaft is controlled.

2. The device as recited in claim 1,
wherein the second housing shell on the transmission side is provided with a pump neck in the region of the concentric opening, the pump neck non-rotatably engageable with the oil pump on the transmission side, at least a portion of an oil flow of the oil pump being pumped into the device.

3. The device as recited in claim 1,
wherein oil for the device is supplied by the oil pump, and the oil pump is operated by an electric motor.

4. The device as recited in claim 3,
wherein the oil output of the electric motor-operated oil pump is independent of the rotational speed of the internal combustion engine.

5. The device as recited in claim 4,
wherein the oil output of the electric motor-operated oil pump is a function of the temperature of oil flowing out of the device.

6. The device as recited in claim 1,
wherein the driving disk is a flywheel.

7. The device as recited in claim 1,
wherein the driving disk is a flexible disk.

8. The device as recited in claim 1,
wherein the device is a wet clutch.

9. The device as recited in claim 8,
wherein the wet clutch is equipped with a torsion damper, and wherein the torsion damper includes spiral coiled springs.

10. The device as recited in claim 9,
wherein, to provide the power flow in the wet clutch:
one end of the springs bear against drivers on an interior of the housing and the other end of the springs bear against an annular outlet part;
the outlet part engages with a first axially displaceable disk carrier, and the first disk carrier is engaged, in an axially displaceable manner, with a portion of the plurality of friction disks; and
a second disk carrier is engaged with a remainder of the plurality of friction disks, the second disk carrier being connected to the hub.

11. The device as recited in claim 9,
wherein to provide the power flow in the wet clutch:
a first disk carrier is connected to an interior the housing, and the first disk carrier engages a portion of the plurality of friction disks in an axially displaceable manner;
a second disk carrier engages a remainder of the plurality of friction disks;
the second disk carrier is connected to an inlet part of the damper;
the inlet part acts on one end of the springs and the other end of the springs act on an outlet part; and
the outlet part is connected to the hub.

12. The device as recited in claim 8,
wherein a return device is located in the housing to support an oil return flow.

13. The device as recited in claim 12, wherein the return device includes at least one spiral discharge tube.

14. The device as recited in claim 13,
wherein the discharge tube is located between a radially outward region of the interior of the housing and the concentric opening.

15. The device as recited in claim 13,
wherein the discharge tube is substantially located between a radially outward region of the interior of the housing and a radially inward end of the friction disks.

16. The device as recited in claim 12,
wherein the return device comprises a substantially parallel disk pair, and the oil is pumped out of the radially outward region of the housing to the concentric opening of the housing.

17. The device as recited in claim 1,
wherein the piston includes a point of restriction.

18. The device as recited in claim 1,
wherein the device is a torsion damper, and the torsion damper is implemented using spiral coiled springs.

19. The device as recited in claim 18,
wherein, to provide the power flow in the torsion damper:
one end of the springs bear against drivers on an interior of the housing and the other end of the springs bear against an outlet part which simultaneously engages with the hub in a non-rotatable manner;
the outlet part engages with a first disk carrier, and the first disk carrier engages a portion of the plurality of friction disks in an axially displaceable manner;
a second disk carrier engages with a remainder of the plurality of friction disks, and the second disk carrier is connected to the housing.

20. The device as recited in Claim 19,
wherein, by increasing the compression force on the piston, the friction between the friction disks can be increased from zero to a value at which power flows from the housing, via the friction disks, to the first and second disk carriers and the outlet part.

21. A friction lining for disks in an operative connection between an internal combustion engine of a motor vehicle and a transmission, comprising a friction lining having:
first oil grooves which connect one part of an inner edge of the friction lining to another part of the inner edge of the friction lining along a curve; and
second oil grooves which connect an outer edge of the friction lining to the first oil grooves, the second oil grooves contacting the curved first oil grooves at an acute angle relative to the interior edge of the friction lining.

22. The friction lining as recited in claim 21, wherein a cross section of the second oil grooves is smaller than a cross section of the first oil grooves .

23. The friction lining as recited in claim 21,
wherein at least one of the first oil grooves and the second oil grooves taper in the direction of oil flow.

24. The friction lining as recited in claim 23,
wherein the first and second oil grooves have at least one of a tapered width and a tapered depth.
